(19) United States
(12) Patent Application Publication
(10) Pub. No.: US 2010/0306106 A1
(43) Pub. Date: Dec. 2, 2010

(54) Apparatus system and method of Payment identification means using pulse and fingerprints

(76) Inventor: DOR DAGAN, Natanya (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/472,310

(22) Filed: May 26, 2009

(51) Int. Cl. G06Q 40/00

(52) U.S. Cl. 705/43; 705/44

(57) ABSTRACT

The present invention is in the filed of identification of the human being which charging payment means such as credit card, by his physical appearance, or by e-payment such as telephone call or internet or computerized system or device. More particular, the present invention adding to the debit system an additional system that is to insure that the identity of the user making the payment means is the alleged person whom is the credit card owner for example, this achieved by the invention system that require the finger print data and at the same immediate time the pulse of the finger that attached to the device. That is to be achieved and detect by the system at the same time, when the person put his finger for the purpose of examine his fingerprint matching to the system fingerprint database to the owner personal data from the credit card company for example. The present invention innovates in a system and method that has a device suitable for the user finger, connected to a computerized base or center dedicated with software that enable the optional detecting of a human body unordinary physical measurement to a second opinion or detection regarding the existing purchasing act.

### FIELD OF THE INVENTION

The present invention relates to an apparatus system and method which has a device suitable for the user finger, connected to a computerized base or center dedicated whit software that enabling the identification of the fingerprint placed in the invention apparatus and the verification that that finger is including a body pulse and it's not fake.

### BACKGROUND OF THE INVENTION

Until today people used credit cards in order to execute payments and various transactions such as purchasing equipment and devices, withdrawing money from the Mac machine an so on.

Until today the user had to carry his credit card around with him every place he went and problem was that at the times it would malfunction, get lost, get stolen or forgotten and was not available for the user to use when necessary.

Other objects and advantages of the invention will become apparent as the description proceeds.

The object of the present inventions is to enable the user to use payment identifications means, which do not require physical accessories to prove the identity of the user and makes the payment process for products and services easier and more efficient by measuring the pulse of the user and identifying his fingerprint.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

The present invention is designed to make the daily payment operations easier and more efficient for users implementing transactions.

The present invention enabling a person to purchase equipment and services by using the identity of the user of certain account with complete certainty and without the user having to take accessories with him to prove his identity.

According to another preferred embodiment of the present invention the user will place his index finger on a sensor which retrieves the user fingerprint and compares it to the resource of fingerprints existing in the credit card companies and in addition and at the same time (or sometimes before or after the fingerprint identification) there will be sensor which indicates and reveals that a finger has been placed on the sensor which has a pulse (is connected to the right person), which confirms that the person who placed the finger is indeed amongst the living and not plastic or different type of replica of the fingerprint.

According to the present invention only after confirming the two variables of reading and identifying the fingerprint in comparison with the existing bank account number and after confirming that the fingerprint has a pulse, the user will be able to type in a secret personal code which will enable him to withdraw money from the MAC machine.

According to a different preferred embodiment of the present invention it is possible to use the MAC machine terminal operated by the user placing his finger on the identification lens and only afterwards typing in his secret personal code and selecting the desired operation.

According to the present invention the pulse meter can also identify the intensity of the pulse of the person in authorized use identical to the normal pulse of the user, in comparison to person trying to steal a fingerprint from a user and placing it on his fingerprint, whereas by measuring the intensity of the pulse the device can confirm that the pulse intensity is normal and it is not a person who placed plastic on his finger simulating a certain fingerprint.

According to one of the preferred embodiments of the present invention it is possible to use terminal located in various businesses and pay for credit transactions using the fingerprint which charges the credit account.

The operation of the credit computer or cash register is used as credit card would be used, when purchasing at the cash register the client places his finger on the credit fingerprint identification lens, the computer or any other device will identify the client and present his details after confirming successful identification the payment will take place.

According to a different preferred embodiment of the present invention it is possible to use terminal in any place the users identification is required where there is not a person but machine providing services as a Video rental library, border terminal or house entrance.

According to the present invention it is possible to read prints of one finger or more for example, thumb, the small finger, third finger, index finger (any of the fingers of the hand).

### BRIEF DESCRIPTION OF THE DRAWINGS

The accompanying drawings, which are incorporated inside and form a part of this specification, illustrate embodiments of the invention and together with the description, serve to explain by way of example only, the principles of the invention:

FIG. 1 illustrates an isometric schema of the method of payment using a pulse meter and fingerprint used in a MAC machine according to the present invention.

FIG. 2 illustrates an isometric schema of the method of payment using the pulse meter and fingerprint used in cash register in convenience store, a kiosk, supermarket or any other place according to the present invention.

FIG. 3 illustrates an isometric schema of the method of payment using the pulse meter and fingerprint enabling use of a device enabling purchasing from home using internet sites.

FIG. 4 illustrates schema of the side section of the device for payment using the pulse meter and fingerprint according to the present invention.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

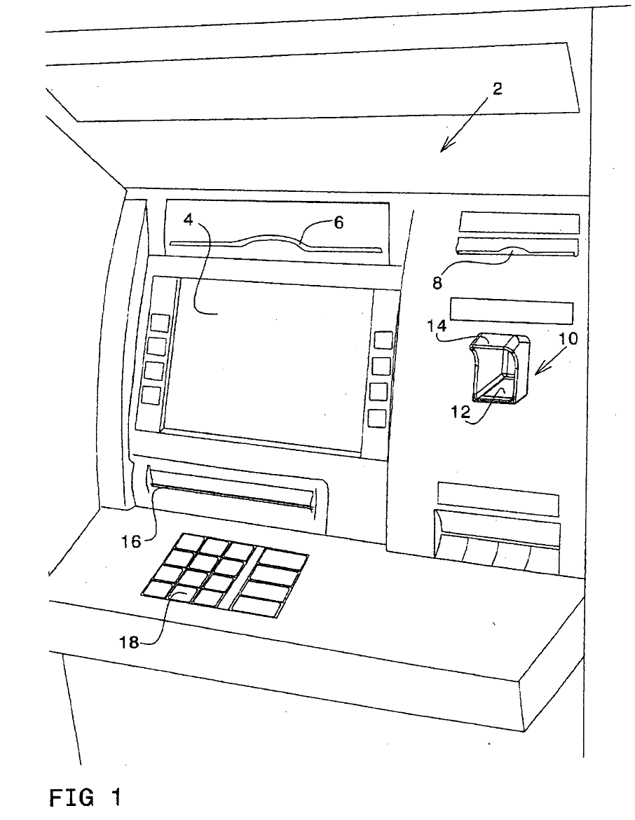

Referring to FIG. 1, illustrates an isometric schema of the method of payment using a pulse meter and fingerprint used in a MAC machine (2) according to the present invention.

The method of operation of the MAC machine is by user placing his finger in the combined pulse meter and fingerprinting device built into the MAC machine (10) on the sensor identifying the fingerprint (12) protected by the shield for identification lens (14) an only afterwards typing in the secret code on the key panel (18) and selecting the desired action displayed on the MAC machine display (4). Illustration (6) is the printout opening, and illustration (8) is the small note opening.

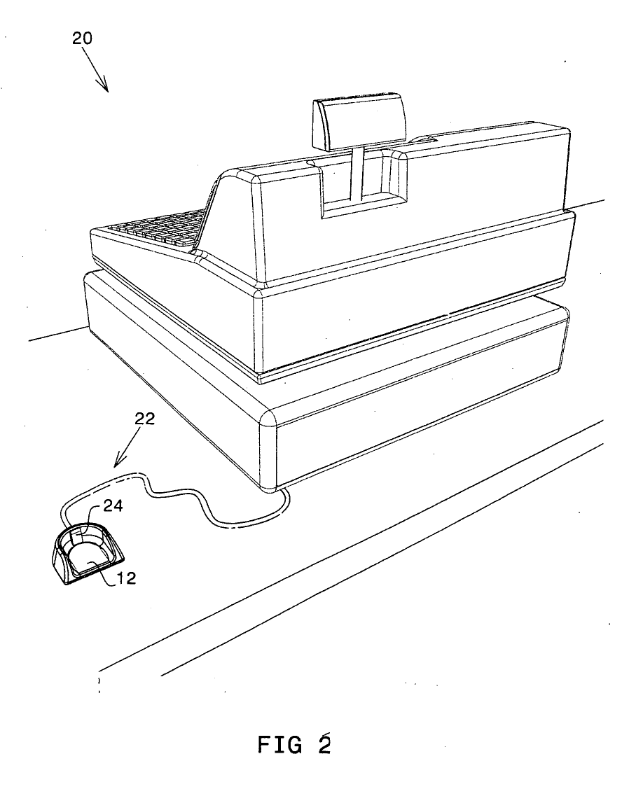

Referring to FIG. 2, illustrates an isometric schema of the method of payment using a pulse meter and fingerprint used in cash register in convenience store, a kiosk, supermarket or any other place (20) according to the present invention.

A combined pulse meter and fingerprinting device in cash register (22), the user places his finger on the sensor, which identifies the fingerprint (12), the pulse meter (24) which measures the users pulse.

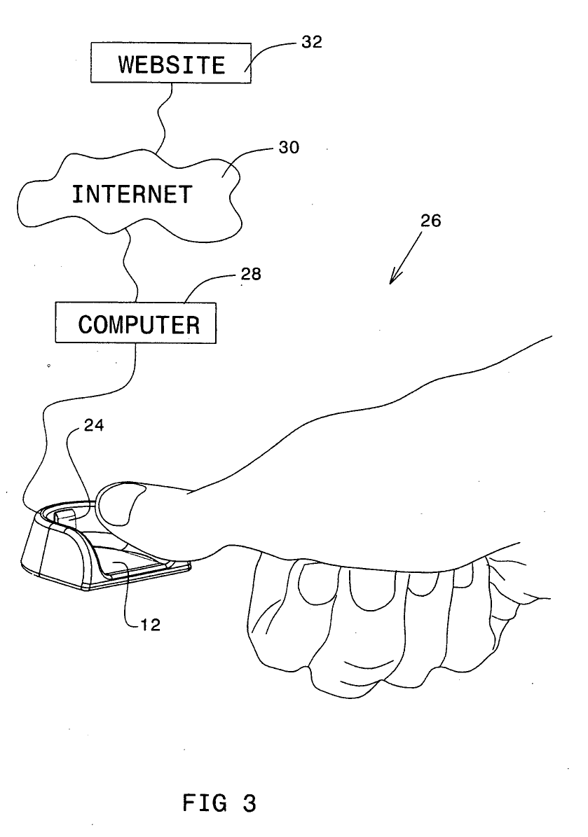

Referring to FIG. 3 illustrates an isometric schema of the method of payment using the pulse meter and fingerprint enabling use of a device enabling purchasing from home using internet sites (26). The user places his finger on the sensor, which identifies the fingerprint (12), the pulse meter (24) measures the users pulse, and the information is received by the computer (28) and transferred through the internet (30) to the shopping website (32) to confirm or decline the implementation of the payment.

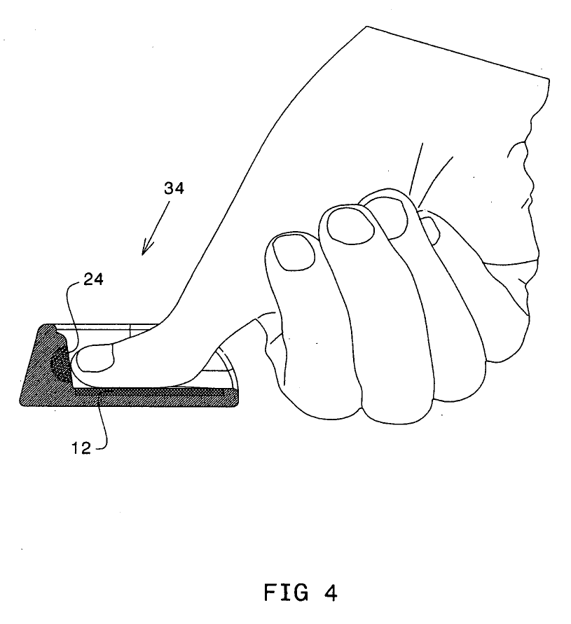

Referring to FIG. 4 illustrates schema of the side section of the device for payment using the pulse meter and fingerprint (34) according to the present invention. In the illustration it is possible to view the user placing his finger on the sensor, which identifies the fingerprint (12), the pulse meter (24), which measures the users pulse or pulse intensity compare to normal reaction, such as in a machine that checks if person is telling true or false answers.

What is claimed is:

1. Payment identification means using pulse meter and fingerprints, which makes it easier and more efficient to pay for products and services by measuring the pulse of the user and identifying his fingerprint, when user will place his finger on sensor which retrieves the users fingerprint and compares it to a resource of fingerprints existing in the bank or credit card companies and measures the user pulse to authorize the payment.

2. Payment identification means using pulse meter and fingerprints according to claim 1, which enables use of MAC machine terminal by the user placing his finger on the identification lens and only validation of the two variables of reading and identifying the fingerprint in comparison to an existing bank account and after confirming the finger has a pulse the user can type in personal secret code which will enable withdrawing money from a MAC machine or selecting another operation.

3. Payment identification means using pulse meter and fingerprints according to claim 1, which enables identifying and conforming a normal pulse intensity of an authorized user, to prevent theft of fingerprints from an authorized user using various means.

4. Payment identification means using pulse meter and fingerprints according to claim 1, which enables use of terminal located in various businesses in order to pay for credit transactions by charging a credit account.

5. Payment identification means using pulse meter and fingerprints according to claim 1, which enables use of credit computer or cash register when purchasing at a cash register by placing the clients finger on the credit fingerprint identification lens for identification and after confirmation and successful identification the payment is implemented.

6. Payment identification means using pulse meter and fingerprints according to claim 1, which enables use of unmanned service terminal anywhere for user identification purposes and implementing payments, a video store, border terminal, house entrance.

7. Payment identification means using pulse meter and fingerprints according to claim 1, which enables use of prints read of one finger or more of any of the fingers of the hand for reading the fingerprint identification and pulse measurement.

8. Payment identification means using pulse meter and fingerprints as illustrated and described above.

9. Payment identification means using pulse meter and fingerprints as illustrated and described above further comprising machine such as in a machine that checks if person is telling true or false answers, and whenever the reading from the pulse is not in the normal level, the identification is not confirmed and the request for Payment approval denied.
